(19) United States
(12) Patent Application Publication
(10) Pub. No.: US 2026/0250857 A1
(43) Pub. Date: Aug. 27, 2026

(54) ELECTROLYSIS DEVICE WITH NATURAL CIRCULATION

(71) Applicant: H2I Greenhydrogen GmbH, Wallern an der Trattnach (AT)

(72) Inventors: Bianca Grabner, Bad Waltersdorf (AT); Marie-Gabrielle Macherhammer, Graz (AT); Matthias Ranz, Heiligenkreuz am Waasen (AT); Michael Richter, Graz (AT); Alexander Trattner, Graz (AT); Bernd Cermenek, Graz (AT); Philipp Schneider, Graz (AT); Dietmar Neubacher, Graz (AT)

(21) Appl. No.: 19/104,703

(22) PCT Filed: Aug. 17, 2023
(86) PCT No.: PCT/AT2023/060278

§ 371 Date: Feb. 18, 2025

(30) Foreign Application Priority Data
Aug. 19, 2022 (AT) A50642/2022

(51) Int. Cl. C25B 9/23; C25B 1/04; C25B 9/77; C25B 15/08

(52) U.S. Cl. CPC C25B 9/23; C25B 1/04; C25B 9/77; C25B 15/08

(57) ABSTRACT

An electrolysis device for producing hydrogen through electrochemical reaction from an aqueous alkali solution is disclosed. The electrolysis device includes an anodic half cell and a cathodic half cell. The anodic half cell and the cathodic half cell are separated via a membrane and the alkali solution can flow through the cathodic half cell. The anodic half cell includes an anodic electrode and the cathodic half cell includes a cathodic electrode. The anodic electrode, the cathodic electrode and the membrane form a membrane-electrode unit. In normal operation of the electrolysis device, an initial fill quantity of the alkali solution in the cathodic half cell can be changed only by diffusion processes through the membrane-electrode unit and/or through electrochemical reaction of the alkali solution in the membrane-electrode unit.

### CROSS-REFERENCE TO RELATED APPLICATIONS

This application claims priority to International Patent Application No. PCT/AT2023/060278 filed Aug. 17, 2023, which also claims priority to Austrian Patent Application AT A 50642/2022 filed Aug. 19, 2022, the contents of each of which is hereby incorporated by reference in its entirety.

### TECHNICAL FIELD

The invention relates to an electrolysis device and a method for producing hydrogen through electrochemical reaction from an aqueous alkali solution.

### BACKGROUND

EP 3 831 986 A1 discloses a gas production device comprising an electrolysis vessel, comprising an anode chamber, a cathode chamber, and an ion-permeable separator membrane separating the anode chamber and the cathode chamber, wherein the anode chamber houses an anode and generates oxygen gas, and the cathode chamber houses a cathode and produces hydrogen gas. The gas production device further comprises a first electrolyte circulation system, a second electrolyte circulation system, and an electrolyte exchanger. The first electrolyte circulation system comprises a first circulation tank receiving and storing a first electrolyte flowing out from the anode chamber, and a first circulation pump supplying the first electrolyte stored in the first circulation tank to the anode chamber. The second electrolyte circulation system comprises a second circulation tank receiving and storing a second electrolyte flowing out from the cathode chamber, and a second circulation pump supplying the second electrolyte stored in the second circulation tank to the cathode chamber. On the one hand, the electrolyte exchanger transfers part of the first electrolyte present in the first electrolyte circulation system into the second electrolyte circulation system, and on the other hand transfers part of the second electrolyte present in the second electrolyte circulation system into the first electrolyte circulation system.

Furthermore, WO 2011 004 343 A1 discloses a device for the electrolytic production of hydrogen from an aqueous alkali solution, starting from the dry cathode, wherein the device comprises the following:
two half cells, one anodic and one cathodic, separated by an anion-exchange membrane, the surface of which that is in contact with the cathodic half cell being a membrane-electrode unit MEA, and
wherein the alkali solution is only present in the anodic half cell.

US 2012 234 676 A1 discloses a device for providing chlorine and soda lye from sodium chloride, wherein the device has a container with two receiving volumes for fluids, wherein the receiving volumes are separated by a membrane and an electrode is received in each of the receiving volumes. A voltage can be applied to the electrodes, such that a cathode and an anode are formed. Sodium chloride is supplied to a first receiving volume of the receiving volumes with the anode received therein. Through an electrochemical process in the device, in a second receiving volume of the receiving volumes with the cathode received therein a soda lye is formed and removed, wherein furthermore chlorine and hydrogen are also produced and removed as by-products on the electrodes.

US 2021 292 917 A1 discloses a device for the electrochemical production of hydrogen from water. The device comprises a cathodic half cell, an anodic half cell and a membrane-electrode unit MEU by means of which the half cells are separated from one another. A tank for receiving water is connected to each half cell via two fluid lines each. Water can thus flow from a tank into the half cell and then flow back from the half cell to the tank. The tanks have a fill volume such that during operation of the device the half cells can be completely filled and thus flooded with water, whereby the MEU can be completely moistened with water.

The object of the present invention was to overcome the disadvantages of the prior art and provide a device and a method by means of which, in particular, advantageous effects are achieved with regard to the operational safety and the effectiveness of the device.

### SUMMARY

This object is solved by a device and a method according to the claims.

Unlike the gas production device known from EP 3 831 986A1, the electrolysis device according to the invention can be operated without active means for generating a flow or circulation. This has a number of advantages and in particular surprising effects, which shall be explained in more detail in the following.

Contrary to the device as per WO 2011 004 343 A1, the electrolysis device according to the invention is operated in such a way that during operation of the electrolysis device, an electrolyte is present both in the anodic half cell and in the cathodic half cell of the device. This itself has several advantages as described in the following.

The electrolysis device according to the invention for producing hydrogen through electrochemical reaction from an aqueous alkali solution comprises an anodic half cell and a cathodic half cell. The anodic half cell and the cathodic half cell are separated by means of a membrane and the alkali solution can flow through the cathodic half cell. The anodic half cell comprises an anodic electrode and the cathodic half cell comprises a cathodic electrode, wherein the anodic electrode, the cathodic electrode and the membrane form a membrane-electrode unit. In normal operation of the electrolysis device, an initial fill quantity of alkali solution in the cathodic half cell can be changed only by diffusion processes through the membrane-electrode unit and/or by electrochemical reaction of the alkali solution in the membrane-electrode unit.

As in the cathodic half cell, an alkali solution for the electrolysis process can be used in the anodic half cell. It is, however, conceivable that ultrapure water can be used in the anodic half cell, in particular with a correspondingly adapted membrane or an adapted membrane-electrode unit.

In the present description, a membrane is understood as a separating but nonetheless electrolytically conducting partition in the electrolysis device, said electrolysis device being substantially an electrochemical cell. In the broadest sense in electrochemistry, the diaphragm can be seen as synonymous with the membrane. The separation of the half cells by the membrane allows operation with respectively different concentrations of the alkali solution or with respectively different fluids or electrolytes in the half cells.

Diffusion processes are understood as all transport processes through the membrane or the membrane-electrode unit, which comprises gas diffusion, water transport mechanisms, gas permeation, or the diffusion of other educts or products of the electrochemical reaction of the electrolysis device.

In this sense, the membrane or the membrane-electrode unit is not considered to be an active means for generating flow. The supply of electrical energy to the electrodes and the outgassing or generation of products from the electrochemical reaction and the flow induced by the products in the half cells are not considered to be active means for generating flow, either.

The electrolysis process causes a substance transport through the membrane at the membrane-electrode unit due to diffusion processes, where said substance transport results as a passive effect of the electrochemical reaction or of the concentration difference of the respective solutions or fluids/electrolytes in the half cells arising between the anodic half cell and the cathodic half cell and a resulting osmotic pressure.

Normal operation is understood as an operating mode in which a product, such as molecular hydrogen, is continuously produced by means of electrochemical reaction. Operating modes such as maintenance, flushing and the like are thus not to be understood as normal operation.

The electrolysis device can comprise a cathode inlet and a cathode outlet, wherein the cathode inlet and the cathode outlet are fluidically couplable with the cathodic half cell. The cathode inlet and the cathode outlet can also be fluidically couplable.

The cathode circuit of the electrolysis device can initially be filled with an alkali electrolyte or an aqueous alkali solution, whereby the solution flows through the cathodic half cell. The anodic half cell can be filled with the same alkali solution or an alkali solution with an equally high, higher, or lower substance concentration, or with ultrapure water.

In normal operation of the electrolysis device, on the cathode side water can be split into hydrogen and OH ions and the OH ions can be transported through the membrane into the anodic half cell. During ongoing normal operation, the substance concentration of the alkali solution on the cathode side is thus increased and a chemical gradient between the anode-side electrolyte and the cathode-side electrolyte is generated.

The transport of the OH ions from the cathodic half cell to the anodic half cell can be ensured by means of H₂O carrier molecules. Since the initial fill quantity of electrolytes in the cathodic half cell is not changed by active means in normal operation, ultrapure water or water molecules are transported through the membrane from the anodic half cell to the cathodic half cell through osmosis or the system's trying to achieve concentration balance. Ultrapure water or water molecules can thus only be provided as an educt for producing molecular hydrogen in the cathodic half cell through diffusion processes through the membrane. There-after, in normal operation of the electrolysis device the ultrapure water required for producing hydrogen is only supplied to the anodic half cell.

The electrolysis device according to the invention provides the advantage that in normal operation, a greater substance concentration of the electrolyte is present in the cathodic half cell than in the anodic half cell, whereby the conductivity of the electrolytes in the cathodic half cell and thus the efficiency of the electrolysis device are improved. Furthermore, the electrolysis device independently regulates itself in the event of a change of the power applied to the electrodes by aligning the substance concentration difference between the anode-side electrolytes and the cathode-side electrolytes, which subsequently causes an self-regulating demand for ultrapure water in the cathodic half cell. The supply of ultrapure water to the cathodic half cell can thus be controlled or regulated in a simple and robust manner.

A further advantage of the electrolysis device according to the invention is that the cathodic half cell being fully filled with the alkali solution in normal operation provides a natural flame arrester for the hydrogen produced in hydrogen electrolysis. It is further advantageous that in normal operation, the membrane is fully moistened with the alkali solution at all times, such that the membrane is not at risk of drying out or local overload due to overheating, and thus the lifespan of the membrane is improved.

Furthermore, it can be expedient if the membrane is configured as an anion-exchange membrane.

Moreover, it can be provided that the initial fill quantity of alkali solution can be received in the cathodic half cell and in a fluid channel and/or fluid tank that is fluidically coupled with the cathodic half cell, whereby a receiving volume is defined, wherein in normal operation of the electrolysis device the alkali solution in the receiving volume is not subjected to any forced circulation, forced cycling and/or forced movement other than the movement resulting from the electrochemical reaction itself.

In addition to the aforementioned advantages, the effectiveness and overall efficiency of the electrolysis device is improved because no additional energy has to be provided. For example, it is conceivable that the cathode inlet and the cathode outlet are fluidically couplable by means of the fluid channel. By positioning the electrolysis device accordingly, circulation of the alkali solution through the cathodic half cell can nevertheless occur without active means due to the production of hydrogen in hydrogen electrolysis. The thermal stress on the membrane in particular is thereby reduced, and the efficiency of the electrolysis device improved at the same time. A natural circulation can develop during normal operation of the electrolysis device.

Furthermore, it can be provided that in normal operation of the electrolysis device, no active means are provided for circulating and/or pumping the cathode-side alkali solution. In addition to the aforementioned advantages, the effectiveness of the electrolysis device is improved in normal operation. The safety of the electrolysis device in normal operation is also thereby improved, since it is not reliant on any active means and possible error sources and malfunctions can also be minimized.

An embodiment according to which the receiving volume is configured without a pump is also advantageous. Error sources are thereby also minimized and the effectiveness of the electrolysis device improved.

According to a further embodiment, it is possible that the initial fill quantity of alkali solution in the cathodic half cell is dimensioned in such a way that during operation of the electrolysis device, the cathodic half cell is fully flooded with the alkali solution at all times.

It is thereby advantageous that the cathodic half cell being fully filled with the alkali solution in normal operation provides a natural flame arrester for the hydrogen produced in hydrogen electrolysis. It is further advantageous that in normal operation, the membrane is fully moistened with the alkali solution at all times, such that the membrane is not at risk of drying out or local overload due to overheating, and thus the lifespan of the membrane is improved.

Furthermore, it can be expedient if the receiving volume is configured in such a way that in normal operation of the electrolysis device, the cathodic half cell of the electrolysis device is always fully flooded with alkali solution, wherein a separation device is fluidically couplable with the receiving volume, such that the draining of alkali solution from the receiving volume is preventable during removal or separation of product gas from the receiving volume.

This means that the alkali solution can remain in the intended receiving volume, whilst at the same time the product of the electrochemical reaction can be removed from the cathodic half cell by means of the separation device. It is also advantageous that a pressure operation of the electrolysis device is enabled in a simple manner, insofar as the separation device provides the counterpressure to the receiving volume. Since the receiving volume receives at least a certain minimum quantity of alkali fluid in normal operation such that the membrane is constantly moistened with the fluid, the proportion of gas in relation to alkali fluid in the receiving volume is low, thus improving the safety of pressure operation of the electrolysis device.

Furthermore, it can be provided that in a steady and stationary state of the electrolysis device, the supply of educts for the electrochemical reaction in the cathodic half cell can be provided only by diffusion processes of the educts through the membrane-electrode unit.

The constructional design of the electrolysis device is thus simplified since in normal operation, fresh water or ultrapure water has to be supplied to the electrolysis device only via the anodic half cell. The electrolysis device can thereby be produced in an even more economical way, in particular if it is intended for cathode-side pressure operation, since fewer parts or pressure-proof components are required.

Furthermore, it can be provided that the cathodic electrode and/or a cathode-side surface of the membrane is configured to be or is hydrophilic. The already described diffusion processes or the overall sequence of the electrochemical reaction in the electrolysis device are thus facilitated, which increases the effectiveness and subsequently the efficiency of the electrolysis device.

According to a particular embodiment, it is possible that the anodic electrode and/or the cathodic electrode is or are formed by applying catalytically active materials to the membrane and or by applying catalytically active materials to porous carrier structures contacted with the membrane.

In particular by using a porous carrier material such as a metal foam or similar, the diffusion or transport processes of the educts and products of the electrochemical reaction in the electrolysis device are improved.

According to an advantageous embodiment, it can be provided that the anodic electrode and/or the cathodic electrode are free from precious metals.

This provides the economic advantage that cheaper materials can be used than precious metal-based metals.

In particular, it can be advantageous if ultrapure water or a lye with a first substance concentration in the range of between 0.1 mol/l and 2 mol/l, in particular between 0.5 mol/l and 1 mol/l, can be received in the anodic half cell.

Furthermore, it can be provided that the lye is a potash lye or soda lye. Moreover, it is conceivable that solutions containing (bi-)carbonate are used.

Furthermore, it can be provided that the alkali fluid for the initial fill quantity in the cathodic half cell is a lye with a second substance concentration, wherein the first substance concentration is as high as or higher than the second substance concentration.

An osmotic pressure thus also acts between the half cells even in a standby mode where no voltage is applied to the electrodes. The electrolysis device can thus be operated for longer and with pressure constantly applied, and in a standby mode or when shutting down the electrolysis device the diffusion of the product, such as molecular hydrogen, is at least partially prevented or is more simply preventable.

An embodiment according to which it can be provided that the membrane-electrode unit can absorb a differential pressure between the anodic half cell and the cathodic half cell, wherein the differential pressure is in the range of between 0 bar and 100 bar, or in particular between 5 bar and 30 bar, is also advantageous.

It is thereby advantageous that an intended pressure of the product of the electrolysis need not be generated with an additional means, since the electrolysis device is already operated at pressure. This is advantageous in relation to the overall efficiency of the electrolysis device when incorporated in a production plant for hydrogen, for instance. This is advantageous in conjunction with the electrolysis device according to the invention in which the half cells are fully flooded with electrolyte, since the gas volume in the half cells is particularly low and the electrolysis device can thus be operated with a fast reaction time and in a dynamic manner.

According to the invention, an electrolysis cell stack is claimed, said electrolysis cell stack comprising a plurality of anodic half cells, cathodic half cells and membrane-electrode units arranged in a row corresponding to the functional configuration of the electrolysis device according to the invention. The cathodic half cells are fluidically couplable by means of at least one flow channel, wherein the cathodic half cells and the at least one flow channel form a cathode volume, wherein during operation of the electrolysis cell stack an initial fill quantity of alkali solution in the cathode volume can be changed only by diffusion processes through the membrane-electrode unit and/or through electrochemical reaction of an educt or educts or of the alkali solution in the membrane-electrode units.

It is thereby advantageous that the cathode volume can be provided as a combination of all cathodic half cells of the electrolysis cell stack to receive the alkali solution. In particular at high performance of the individual electrolysis devices, transient effects when starting the latter in normal operation can thereby be lessened. This increases safety during the electrolysis process.

According to the invention, an electrolysis plant is claimed, said electrolysis plant comprising a plurality of electrolysis cell stacks according to the invention. The electrolysis plant comprises at least a connection line or a connection channel, wherein the cathode volumes of the electrolysis cell stacks are fluidically couplable by means of the connection line, wherein the electrolysis plant comprises a gas separation device, wherein the gas separation device is fluidically couplable with the cathode volumes and is configured in such a way that it can separate the product produced by means of electrochemical reaction from the alkali solution, wherein the removal of the alkali solution from the cathode volumes is preventable by means of the gas separation device.

It is thereby advantageous that the fluidically couplable cathode volumes can be provided as a combination of all cathodic half cells of the electrolysis plant to receive the alkali solution. In particular at high performance of the electrolysis plant, transient effects when starting the latter in normal operation can thereby be lessened. This increases safety during the electrolysis process.

In particular, the use of the electrolysis plant according to the invention is advantageous if the product is molecular hydrogen.

Furthermore, according to the invention, a method for producing hydrogen through electrochemical reaction from an aqueous alkali solution is claimed, said method comprising the following method steps:
providing an electrolysis device, wherein the electrolysis device comprises an anodic half cell and a cathodic half cell, wherein the anodic half cell and the cathodic half cell are separated by means of a membrane and the alkali solution can flow through the cathodic half cell and an aqueous alkali solution or ultrapure water can flow through the anodic half cell, wherein the anodic half cell comprises an anodic electrode and the cathodic half cell comprises a cathodic electrode, wherein the anodic electrode, the cathodic electrode and the membrane form a membrane-electrode unit;
filling the anodic half cell with an aqueous alkali solution or with ultrapure water and filling the cathodic half cell with an initial fill quantity of alkali solution, such that the half cells are fully flooded or such that the membrane-electrode unit is fully submerged in the alkali solution on the cathode side;
application of a voltage between the anodic electrode and the cathodic electrode; characterized in that
   in normal operation of the electrolysis device or when voltage is being applied between the anodic electrode and the cathodic electrode, the initial fill quantity of alkali solution in the cathodic half cell is changed only by diffusion processes through the membrane-electrode unit or through the membrane and/or through electrochemical reaction of the alkali solution in the membrane-electrode unit.

In particular, it can be provided that an anion-exchange membrane is used as a membrane.

Furthermore, it can be provided the initial fill quantity of alkali solution is received in the cathodic half cell and in a fluid channel and/or fluid tank that is fluidically coupled with the cathodic half cell, whereby a receiving volume is defined, wherein in normal operation of the electrolysis device the alkali solution in the receiving volume is not subjected to any forced circulation, forced cycling and/or forced movement other than the movement resulting from the electrochemical reaction itself.

In addition to the aforementioned advantages, the effectiveness and overall efficiency of the electrolysis device is improved because no additional energy has to be provided. For example, it is conceivable that the cathode inlet and the cathode outlet are fluidically couplable by means of the fluid channel. By positioning the electrolysis device accordingly, circulation of the alkali solution through the cathodic half cell can nevertheless occur without active means due to the production of hydrogen in hydrogen electrolysis. The thermal stress on the membrane in particular is thereby reduced, and the efficiency of the electrolysis device improved at the same time. A natural circulation can develop during normal operation of the electrolysis device.

An embodiment according to which it can be provided that in normal operation of the electrolysis device no active means are used to generate a flow of the cathode-side alkali solution, wherein the membrane-electrode unit is excepted from that, is also advantageous.

In addition to the aforementioned advantages, the effectiveness of the electrolysis device is improved in normal operation. The safety of the electrolysis device in normal operation is also thereby improved, since it is not reliant on any active means and possible error sources and malfunctions can also be minimized.

The method according to the invention can further comprise the following method step:
dimensioning the cathode-side alkali solution in such a way that in normal operation of the electrolysis device, the cathodic half cell is fully flooded with the alkali solution at all times.

It is thereby advantageous that the cathodic half cell being fully filled with the alkali solution in normal operation provides a natural flame arrester for the hydrogen produced in hydrogen electrolysis. It is further advantageous that in normal operation, the membrane is fully moistened with the alkali solution at all times, such that the membrane is not at risk of drying out or local overload due to overheating, and thus the lifespan of the membrane used is improved.

The method according to the invention can further comprise the following method step:
supplying an operating fluid in the anodic half cell, wherein the operating fluid is ultrapure water and/or an aqueous alkali solution, wherein in normal operation of the electrolysis device the operating fluid is supplied only on the anode side.

The fixtures and lines required for the electrolysis in normal operation are thus reduced, which improves the safety and effectiveness of the electrolysis device.

According to a further embodiment, it is possible that an electrode that is free from precious metals is used as an anodic electrode and/or that an electrode that is free from precious metals is used as a cathodic electrode.

This provides the economic advantage that cheaper materials can be used than precious metal-based metals.

Moreover, it can be expedient if ultrapure water or a lye with a first substance concentration in the range of between 0.1 mol/l and 2 mol/l, in particular between 0.5 mol/l and 1 mol/l, is received in the anodic half cell.

Furthermore, it can be provided that a lye with a second substance concentration is used as the alkali fluid for the initial fill quantity in the cathodic half cell, wherein the first substance concentration is as high as or higher than the second substance concentration.

An osmotic pressure thus also acts between the half cells even in a standby mode where no voltage is applied to the electrodes. The electrolysis device can thus be operated for longer and with pressure constantly applied, and in a standby mode or when shutting down the electrolysis device, the rediffusion of the product, such as molecular hydrogen, is at least partially prevented or is more simply preventable.

In particular, it can be advantageous if a potash lye or a soda lye is used as the lye.

For better understanding of the method according to the invention, the following provides an example detailed description of possible process steps of the method according to the invention or of possible process steps carried out in the electrolysis device.
Initial filling of the cathodic half cell: cathodic half cell and potential connection lines or fluid channels/fluid tanks, hereinafter referred to as the cathode volume, are filled with a certain amount of alkali solution.
Fill quantity and positioning of cathode volume: Any potentially provided fluid channels, fluid tanks or connection lines of the cathode volume are predominantly located above the highest fill level of the respective cathodic half cells. Full moistening of the membrane on the cathode side is thus guaranteed even at the minimum fill quantity.
Inertization of the cathodic half cell: The remaining air is purged from the remaining cathode volume by means of nitrogen and the cathode volume is closed, which can potentially be carried out by means of the separation device or the gas separation device. This ensures that no explosive atmosphere can develop in the cathode volume.
Initial anode condition: The anodic half cell initially contains an alkali electrolyte or alkali solution with a first substance concentration that equates at most to the second substance concentration of the electrolyte in the cathodic half cell. It is also conceivable that the anodic half cell is operable with ultrapure water.
Starting electrolysis: By applying electric current to the electrolysis device or to the electrodes of the electrolysis device, educt water H₂O from the cathodic half cell is initially split into H+ and OH— ions. While molecular hydrogen H₂ is separated in gaseous form in the cathodic half cell, OH— ions diffuse through the membrane into the anodic half cell. The hydrophilic membrane used is only conductive for OH— anions and is impermeable for cations. The membrane can also be referred to as an anion-exchange membrane.
Initial dilution of the electrolyte in the anodic half cell: One part O₂ and ½ parts H₂O result from the OH— ions introduced in the anodic half cell. While the former is separated from the anodic half cell in gaseous form, H₂O reduces the substance concentration of the electrolyte or that in the anodic half cell. The electrolyte in the anodic half cell is thus diluted.
Gas separation and electrolyte circulation in the cathodic half cell: Due to its very low density, the molecular hydrogen produced in the cathodic half cell rises through the outlet connection lines or flow lines at the highest point of the half cell in the cathode volume and collects at the highest point or can be separated there, while the alkali solution or the entrained potassium hydroxide separates through gravity, remains in the cathode volume, and can flow back into the half cell at the lowest point. A natural circulation can thus develop.
Gas separation from the cathodic half cell and differential pressure: The product gas is fed out of the system at the highest point of the cathode volume. The constructional design and the separation device or the gas separation device prevent the alkali solution from draining from the cathode volume. The hydrogen gas or the entire cathode volume can be kept under pressure using external pressure maintenance devices. A check valve in the gas line can prevent higher external system pressures from entering the cathode volume during start-up of the electrolysis device.
Osmotic pressure increase: During operation, the substance concentration of the alkali electrolyte in the cathodic half cell continuously increases through the conversion of the educt water, while in the anodic half cell the substance concentration decreases or the electrolyte in the anodic half cell is diluted due to the entry of H₂O. A substance concentration gradient develops between the two half cells, whereby an osmotic pressure builds which facilitates the transportation of water through the membrane from the anodic half cell to the cathodic half cell.
Achieving equilibrium: If the mass transported as a result of the osmotic pressure is exactly the same as the consumption of the educt water in the cathodic half cell, only fresh water is then used to split into H+ and OH— ions, said water having been transported through the hydrophilic membrane from the anodic half cell to the cathodic half cell. From that point on, the fill quantity or a fill level of electrolytes in the cathodic half cell or the concentration in the cathode volume remains constant.
Equilibrium under differential pressure: Should molecular hydrogen H₂ be held under pressure in the cathodic half cell, the pressure gradient between the cathodic half cell and the anodic half cell curbs the mass transported as a result of the osmotic pressure and the equilibrium shall be achieved only at a higher substance concentration of the electrolyte in the cathodic half cell and thus at a lower fill level or lower fill quantity of electrolyte or alkali solution in the cathode volume.
Concentration increase in the anodic half cell: Once this equilibrium has been achieved, only educt water from the anodic half cell is used for electrolysis, whereby the substance concentration in the anodic half cell begins to increase, or the fill level or fill quantity of electrolytes in the anodic half cell begins to decrease. The substance concentration gradient decreases, and thus the osmotic pressure also decreases, leading to further educt water from the cathodic half cell being used and thus the substance concentration of the electrolyte or the alkali solution in the cathodic half cell increases further.
Regulation of electrolyte concentration in the anodic half cell: Fresh water is supplied to the anodic half cell to avoid an impermissible substance concentration increase, thus maintaining the substance concentration of the electrolyte in the anodic half cell at a constantly low level. This level is independent of the current applied to the electrodes and the prevailing pressure in the cathodic half cell.
Self-regulating system: In contrast to known systems, this substance concentration and mass difference between the anodic half cell and the cathodic half cell is not, however, balanced out by means of pumps or pipelines, but is specifically induced.

By specifically regulating the electrolyte concentration or the substance concentration of the electrolyte in the anodic half cell, a certain fluid level or fill quantity or electrolyte concentration is set in the cathodic half cell depending on the electrical power applied and the differential pressure prevailing between the anodic half cell and the cathodic half cell. By enclosing and circulating the fluid electrolyte in the cathode volume in combination with the controlled supply of fresh water to the anodic half cell, the system is virtually self-regulating or self-stabilizing.
System shutdown: As soon as no current is applied anymore, no further educt water is consumed in the cathodic half cell. The osmotic pressure resulting from the substance concentration gradient and the maintained water transport from the anodic half cell to the cathodic half cell causes the fill level in the cathode volume to rapidly increase again and the substance concentration of the fluid electrolyte to decrease. Since the anodic half cell was constantly topped up with fresh water and the substance concentration in the anodic half cell kept constant, a substance concentration balance in the range of the initial condition is achieved between the anodic half cell and the cathodic half cell. The fill level or fill quantity in the cathode volume then again also equates to the maximum initial fill quantity.
Maintenance and service: The alkali fluid in the cathode volume is replaced at regular maintenance intervals. To do so, all of the fluid is drained at the lowest point and the cathode volume is subsequently refilled. In an electrolysis plant according to the invention, the alkali fluid in the anodic half cell is, however, prepared or replaced centrally.

### BRIEF DESCRIPTION OF THE DRAWINGS

For a better understanding of the invention, it is explained in more detail with reference to the following figures.

These show in significantly simplified, schematic representation:

FIG. 1 an electrolysis device with an anodic half cell and a cathodic half cell;

FIG. 2 an electrolysis cell stack comprising a plurality of electrolysis devices;

FIG. 3 an electrolysis plant comprising a plurality of electrolysis cell stacks.

It is worth noting here that the same parts have been given the same reference numerals or same component configurations in the embodiments described differently, yet the dis-closures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

### DETAILED DESCRIPTION

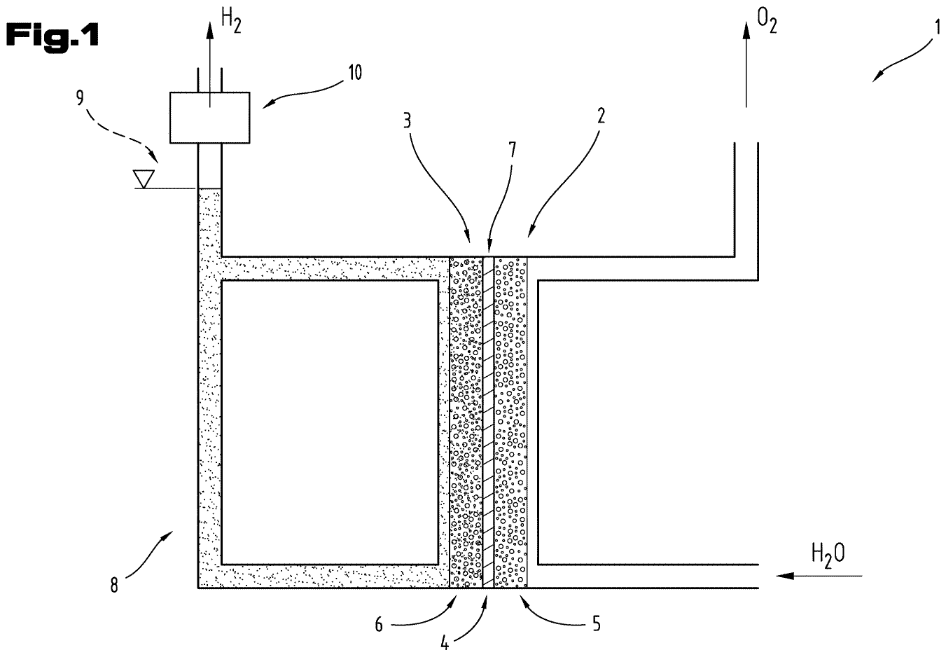

FIG. 1 shows an electrolysis device 1 with an anodic half cell 2 and a cathodic half cell 3 in a highly simplified, schematic representation. The cathodic half cell 3 and the anodic half cell 2 are separated from one another by a membrane 4. The anodic half cell 2 comprises an anodic electrode 5, wherein the anodic electrode 5 can be arranged adjacent to the anode-side surface of the membrane 4. The cathodic half cell 3 comprises a cathodic electrode 6, wherein the cathodic electrode 6 can be arranged adjacent to the cathode-side surface of the membrane 4. The anodic electrode 5, the cathodic electrode 6 and the membrane 4 together form a membrane-electrode unit 7, where said membrane-electrode unit 7 can comprise further elements. The anodic half cell 2 is separated from the cathodic half cell 3 by the membrane 4, wherein the membrane 4 can be configured as an anion-exchange membrane. The anodic electrode 5 and the cathodic electrode 6 can be made from a porous metal conductor such as a metal foam, or be applied directly to the membrane 4.

During operation of the electrolysis device 1, an aqueous alkali solution or ultrapure water can flow through the anodic half cell 2. During operation of the electrolysis device 1, an aqueous alkali solution can flow through the cathodic half cell 3. The cathodic half cell 3 is filled with an initial fill quantity of alkali solution to enable operation of the electrolysis device 1. During ongoing normal operation of the electrolysis device 1, i.e. not including maintenance, flushing and the like, no additional alkali solution is supplied to or drained from the cathodic half cell 3 in an active manner. In normal operation of the electrolysis device 1, the initial fill quantity of alkali solution in the cathodic half cell 3 can be changed only by diffusion processes through the membrane-electrode unit 7 or through the membrane 4 and/or through electrochemical reactions of the alkali solution in the membrane-electrode unit 7.

As in the cathodic half cell 3, an alkali solution for the electrolysis process can be used in the anodic half cell 2. It is, however, conceivable that ultrapure water can be used in the anodic half cell 2, in particular with a correspondingly adapted membrane 4 or membrane-electrode unit 7.

In the present description, a membrane 4 is understood as a separating but nonetheless electrolytically conducting partition in the electrolysis device 1, the latter being substantially an electrochemical cell. In the broadest sense in electrochemistry, the diaphragm can be seen as synonymous with the membrane 4. The separation of the half cells 2, 3 by the membrane 4 allows operation with respectively different concentrations of the alkali solution or with respectively different fluids or electrolytes in the half cells 2, 3.

The membrane 4 can thereby have such a robust construction that a differential pressure in the range of between 0 bar and 100 bar can prevail between the anodic half cell 2 and the cathodic half cell 3. In particular a filling of both half cells 2, 3 with an electrolyte or with ultrapure water or alkali solution facilitates the absorption of such differential pressures. As a synergy, the filling of both half cells 2, 3 improves the safety of the electrolysis device 1, since the filling forms a flame arrester during the production of products that are flammable in free atmosphere.

Diffusion processes are thereby understood as all transport processes through the membrane 4 or the membrane-electrode unit 7, which comprises gas diffusion, water transport mechanisms, gas permeation, or the diffusion of other educts or products of the electrochemical reaction of the electrolysis device 1.

In this sense, the membrane 4 or the membrane-electrode unit 7 is not considered to be an active means for generating flow. The supply of electrical energy to the electrodes 5, 6 and the outgassing or generation of products from the electrochemical reaction and the flow induced by the products in the half cells 2, 3 are not considered to be active means for generating flow, either.

The electrolysis process causes a substance transport through the membrane 4 at the membrane-electrode unit 7 due to diffusion processes, where said substance transport results as a passive effect of the electrochemical reaction or of the concentration difference of the respective solutions or fluids/electrolytes in the half cells 2, 3 arising between the anodic half cell 2 and the cathodic half cell 3 and a resulting osmotic pressure.

Filling both half cells 2, 3 with electrolytes or with an alkali solution or with ultrapure water renders the electrolysis device 1 ready for operation. The initial fill quantity of alkali solution can be received in the cathodic half cell 3 and in a fluid channel 8 and/or a fluid tank that is fluidically couplable with the cathodic half cell 3. A receiving volume 9 that can be filled with the initial fill quantity is thereby defined. The initial fill quantity of alkali solution in the receiving volume 9 is dimensioned in such a way that the membrane-electrode unit 7 can be moistened with alkali fluid on the cathode side at all times during normal operation of the electrolysis device 1.

Normal operation is understood here as an operating mode in which a product, such as molecular hydrogen, is continuously produced by means of electrochemical reaction. Operating modes such as maintenance, flushing and the like are thus not to be understood as normal operation.

During ongoing normal operation of the electrolysis device 1, the quantity of alkali fluid in the receiving volume 9 is not subjected to any circulation, forced cycling and/or forced movement induced by active means. The quantity of alkali fluid in the receiving volume 9 can only be subjected to a passively induced flow, where said passively induced flow can result from the electrochemical reaction and/or the diffusion processes described above and/or through outgassing products of the electrochemical reaction. In any case, no active means for generating a flow during normal operation are provided in the devices or elements that form the receiving volume 9. It is, however, not ruled out that such active means, for instance a pump, can be provided for a different operating mode.

Furthermore, a separation device 10 can be provided, where said separation device 10 is fluidically couplable with the fluid channel 8. By means of the separation device 10, it can be ensured that a product or product gas developing during the electrolysis process can be removed without the alkali solution being drained from the receiving volume 9.

The initial fill quantity of alkali fluid in the receiving volume 9 can change during the normal operation of the electrolysis device 1 due to diffusion processes and the ongoing electrochemical reaction. In any case, in normal operation of the electrolysis device 1, no additional alkali fluid is added to the receiving volume 9 from outside. In a steady and stationary state, which is also to be understood as normal operation, the educts or educt for the electrochemical reaction are, however, provided at least partially by diffusion processes through the membrane-electrode unit 7.

The necessity thereby arises that at least as of a certain operating duration of the electrolysis device 1, ultrapure water is supplied on the anodic half cell 2 side in the case of hydrogen electrolysis. The diffusion processes can further be facilitated by the cathodic electrode 6 and/or a cathode-side surface of the membrane 4 being configured to be hydrophilic. Furthermore, the electrodes 5, 6 can be produced by applying catalytically active materials to the membrane 4. It is also conceivable that the electrodes 5, 6 are produced by applying cata-lytic materials to a porous carrier structure such as a metal foam. In any case, the electrodes 5, 6 can be free from precious metals.

The fluid used in the anodic half cell 2 during operation can, as already mentioned, be ultrapure water or a lye with a first substance concentration in the range between 0.1 mol/l and 2 mol/l. A soda lye, potash lye or another lye with similar electrochemical properties can be used as the lye. The alkali solution used in the cathodic half cell 3 during operation of the electrolysis device 1 can be a lye with a second substance concentration. The first substance concentration can be as high as or higher than the second substance concentration.

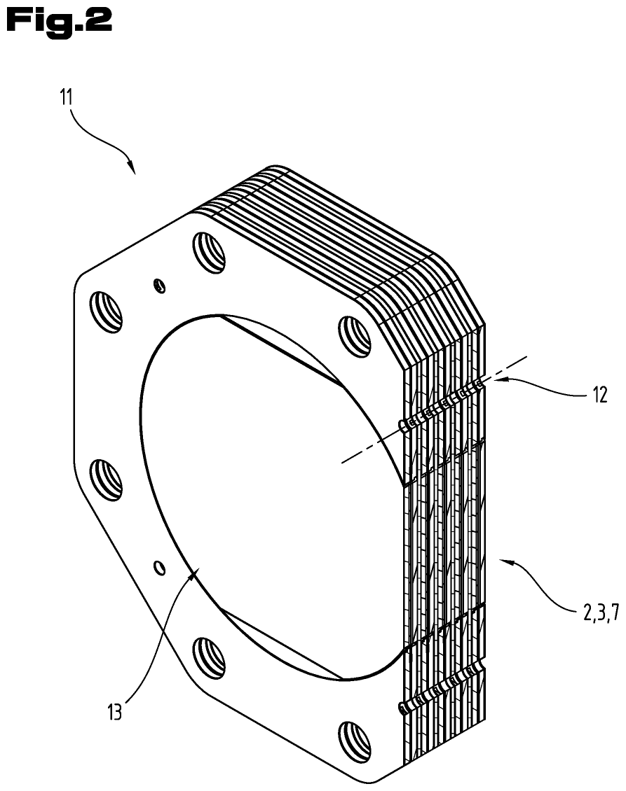

FIG. 2 shows an electrolysis cell stack 11 comprising a plurality of electrolysis devices 1, where the same reference numerals or component designations are used for the same parts as in the preceding FIG. 1. To avoid unnecessary repetition, reference is made to the detailed description in the preceding FIG. 1.

An electrolysis cell stack 11 can comprise a plurality of anodic half cells 2, cathodic half cells 3 and membrane-electrode units 7 arranged in a row. The row arrangement of the individual elements, which can be plate-like, for example, can be performed in an alternating sequence, whereby in any case the functional construction of each electrolysis device 1 in the electrolysis cell stack 11 network must be guaranteed. The cathodic half cells 3 of the electrolysis cell stack 11 are fluidically couplable by means of at least one flow channel 12. The thus fluidically couplable cathodic half cells 3 and the at least one flow channel 12 thereby define a cathode volume 13. It can also be provided that the at least one flow channel 12 is fluidically couplable with a further line or a tank. The cathode volume 13 can thus be ex-tended in order to ensure optimum operation of the electrolysis cell stack, because in any case the alkali solution should completely moisten the respective membrane 4 of a cathodic half cell 3 in normal operation.

Analogously to the electrolysis device 1, the initial fill quantity of alkali solution in the cathode volume 13 can be changed only by diffusion processes through the membrane-electrode unit 7 and/or through electrochemical reaction of an educt or educts or of the alkali solution in the membrane-electrode unit 7.

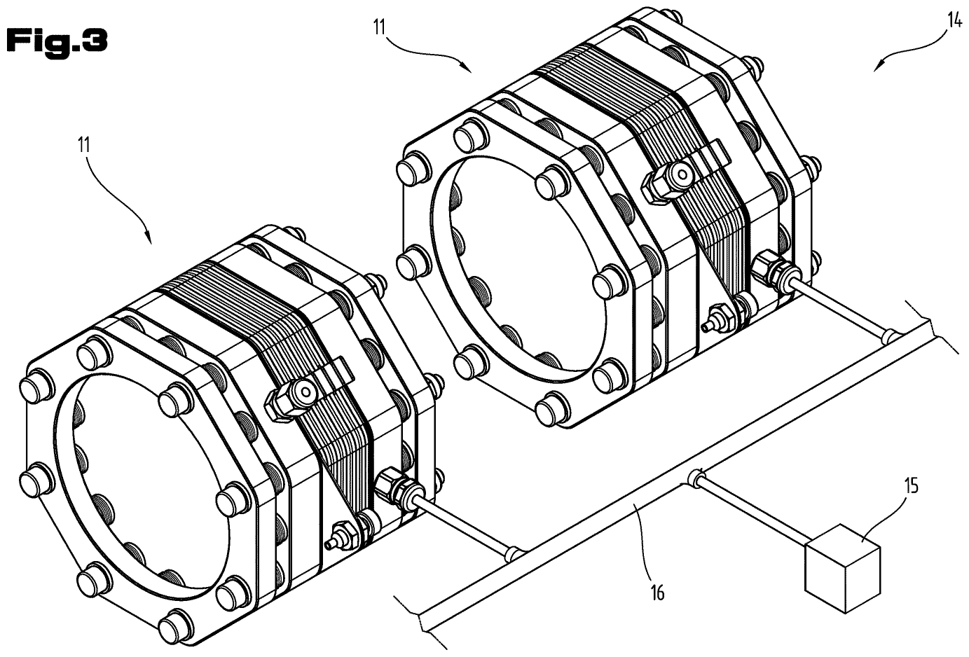

FIG. 3 shows an electrolysis plant 14 comprising a plurality of electrolysis cell stacks 11, where the same reference numerals or component designations are used for the same parts as in the preceding FIG. 1 and FIG. 2. To avoid unnecessary repetition, reference is made to the detailed description in the preceding FIG. 1 and FIG. 2.

The electrolysis plant 14 can comprise a plurality of electrolysis cell stacks 11, wherein the respective cathode volumes 13 of the individual electrolysis cell stacks 11 are fluidically couplable by means of a connection line 16. Furthermore, the cathode volumes 13 are couplable with a gas separation device 15. The gas separation device 15 can be configured to draw off product gas from the electrolysis, such as gaseous molecular hydrogen, without draining the alkali solution in the cathode volumes 13.

Furthermore, the cathodic volumes 13 of the electrolysis cell stacks 11 can be fluidically couplable with a tank. In any case and again analogously to the electrolysis device 1, the initial fill quantity of alkali solution in the cathode volumes 13 can be changed only by diffusion processes through the membrane-electrode unit 7 and/or through electrochemical reaction of an educt or educts or of the alkali solution in the membrane-electrode unit 7.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

1-28. (canceled)

29. An electrolysis device for producing hydrogen through electrochemical reaction from an aqueous alkali solution, comprising:
an anodic half cell and a cathodic half cell,
wherein the anodic half cell and the cathodic half cell are separated via a membrane and the alkali solution can flow through the cathodic half cell,
the anodic half cell including an anodic electrode and the cathodic half cell including a cathodic electrode,
wherein the anodic electrode, the cathodic electrode and the membrane form a membrane-electrode unit,
wherein in normal operation of the electrolysis device, an initial fill quantity of the alkali solution in the cathodic half cell can be changed only by diffusion processes through the membrane-electrode unit and/or through electrochemical reaction of the alkali solution in the membrane-electrode unit,
wherein the electrolysis device is configured:
to fill the anodic half cell and the cathodic half cell with an initial fill quantity of the alkali solution, such that the anodic and cathodic half cells are fully flooded and such that the membrane-electrode unit is fully submerged in the alkali solution on a cathode side, and
in the normal operation of the electrolysis device to only supply an operating fluid to the anodic half cell, wherein the operating fluid is ultrapure water and/or an aqueous alkali solution.

30. The electrolysis device according to claim 29, wherein the initial fill quantity of the alkali solution can be received in the cathodic half cell and in a fluid channel and/or a fluid tank that is fluidically couplable with the cathodic half cell, wherein a receiving volume is defined, wherein in the normal operation of the electrolysis device the alkali solution in the receiving volume is not subjected to any forced circulation, forced cycling and/or forced movement other than the movement resulting from the electrochemical reaction itself, wherein in the normal operation of the electrolysis device no active mechanism is provided to circulate and/or pump the cathode-side alkali solution.

31. The electrolysis device according to claim 29, wherein the initial fill quantity of the alkali solution in the cathodic half cell is dimensionable such that during operation of the electrolysis device, the cathodic half cell is fully floodable with the alkali solution at all times.

32. The electrolysis device according to claim 30, wherein the receiving volume is configured such that in the normal operation of the electrolysis device, the cathodic half cell is always fully flooded with the alkali solution, wherein a separation device is fluidically couplable with the fluid channel, such that a draining of the alkali solution from the receiving volume is preventable during removal and separation of product gas from the receiving volume.

33. The electrolysis device according to claim 29, wherein the anodic electrode and/or the cathodic electrode is/are free from precious metals.

34. An electrolysis cell stack, comprising: a plurality of electrolysis devices arranged in a row, wherein the plurality of electrolysis devices each including:
an anodic half cell and a cathodic half cell,
wherein the anodic half cell and the cathodic half cell are separated via a membrane and the alkali solution can flow through the cathodic half cell,
the anodic half cell including an anodic electrode and the cathodic half cell including a cathodic electrode,
wherein the anodic electrode, the cathodic electrode and the membrane form a membrane-electrode unit,
wherein in normal operation of the electrolysis device, an initial fill quantity of the alkali solution in the cathodic half cell can be changed only by diffusion processes through the membrane-electrode unit and/or through electrochemical reaction of the alkali solution in the membrane-electrode unit,
wherein the electrolysis device is configured:
to fill the anodic half cell and the cathodic half cell with an initial fill quantity of the alkali solution, such that the anodic and cathodic half cells are fully flooded and such that the membrane-electrode unit is fully submerged in the alkali solution on a cathode side, and in the normal operation of the electrolysis device to only supply an operating fluid to the anodic half cell, wherein the operating fluid is ultrapure water and/or an aqueous alkali solution, wherein cathodic half cells are fluidically couplable via at least one flow channel,
wherein the cathodic half cells and the at least one flow channel form a cathode volume, wherein during operation of the electrolysis cell stack an initial fill quantity of the alkali solution in the cathode volume can be changed only by diffusion processes through the membrane-electrode unit and/or through electrochemical reaction of an educt or educts or of the alkali solution in the membrane-electrode units.

35. An electrolysis plant, comprising the plurality of electrolysis cell stacks according to claim 34, further including at least a connection line, wherein the cathode volumes of the electrolysis cell stacks are fluidically couplable via the at least one connection line, and further including a gas separation device, wherein the gas separation device is fluidically couplable with the cathode volumes and is configured such that it can separate the product produced via electrochemical reaction from the alkali solution, wherein the removal of the alkali solution from the cathode volumes is preventable via the gas separation device.

36. A method for producing hydrogen through electrochemical reaction from an aqueous alkali solution, comprising the method steps:
providing an electrolysis device, wherein the electrolysis device comprises an anodic half cell and a cathodic half cell, wherein the anodic half cell and the cathodic half cell are separated via a membrane and the alkali solution can flow through the cathodic half cell, wherein the anodic half cell includes an anodic electrode and the cathodic half cell includes a cathodic electrode, wherein the anodic electrode, the cathodic electrode and the membrane form a membrane-electrode unit;
filling the anodic half cell and filling the cathodic half cell with an initial fill quantity of the alkali solution, such that the anodic and cathodic half cells are fully flooded and such that the membrane-electrode unit is fully submerged in the alkali solution on a cathode side, wherein in normal operation of the electrolysis device and when voltage is being applied between the anodic electrode and the cathodic electrode, the initial fill quantity of the alkali solution in the cathodic half cell is changed only by diffusion processes through the membrane electrode unit and/or through electrochemical reaction of the alkali solution in the membrane-electrode unit;
applying a voltage between the anodic electrode and the cathodic electrode;
supplying an operating fluid in the anodic half cell, wherein the operating fluid is ultrapure water and/or an aqueous alkali solution, wherein in normal operation of the electrolysis device the operating fluid is supplied only on an anode side;
wherein ultrapure water or a lye with a first substance concentration in the range of between 0.1 mol/l and 2 mol/l is received in the anodic half cell, wherein a lye with a second substance concentration is used as the alkali fluid for the initial fill quantity in the cathodic half cell, wherein the first substance concentration is as high as or higher than the second substance concentration.

37. The method according to claim 36, wherein the initial fill quantity of the alkali solution is received in the cathodic half cell and in a fluid channel and/or a fluid tank that is fluidically coupled with the cathodic half cell, wherein a receiving volume is defined, wherein in the normal operation of the electrolysis device, the alkali solution in the receiving volume is not subjected to any forced circulation, forced cycling and/or forced movement other than the movement resulting from the electrochemical reaction itself.

38. The method according to claims 36, wherein in the normal operation of the electrolysis device, no active mechanism for generating a flow of the cathode-side alkali solution is used.

39. The method according to claim 36, further comprising the method step:
measuring the cathode-side alkali solution in such a way that in the normal operation of the electrolysis device, the cathodic half cell is fully flooded with the alkali solution at all times.

40. The method according to claim 36, wherein a potash lye or soda lye is used as the lye.

41. The electrolysis cell stack according to claim 34, wherein the initial fill quantity of the alkali solution can be received in the cathodic half cell and in a fluid channel and/or a fluid tank that is fluidically couplable with the cathodic half cell, wherein a receiving volume is defined, wherein in the normal operation of the electrolysis device the alkali solution in the receiving volume is not subjected to any forced circulation, forced cycling and/or forced movement other than the movement resulting from the electrochemical reaction itself, wherein in the normal operation of the electrolysis device no active mechanism is provided to circulate and/or pump the cathode-side alkali solution.

42. The electrolysis cell stack according to claim 41, wherein the receiving volume is configured such that in the normal operation of the electrolysis device, the cathodic half cell is always fully flooded with the alkali solution, wherein a separation device is fluidically couplable with the fluid channel, such that a draining of the alkali solution from the receiving volume is preventable during removal and separation of product gas from the receiving volume.

43. The electrolysis cell stack according to claim 34, wherein the initial fill quantity of the alkali solution in the cathodic half cell is dimensionable such that during operation of the electrolysis device, the cathodic half cell is fully floodable with the alkali solution at all times.

44. The electrolysis cell stack according to claim 34, wherein the anodic electrode and/or the cathodic electrode is/are free from precious metals.
